(19) United States
(12) Patent Application Publication
(10) Pub. No.: US 2008/0060618 A1
(43) Pub. Date: Mar. 13, 2008

(54) Vapor separator tank

(75) Inventor: Masayuki Daikuhara, Odawara (JP)

Correspondence Address: STAAS & HALSEY LLP, SUITE 700, 1201 NEW YORK AVENUE, N.W., WASHINGTON, DC, 20005, US

(73) Assignee: MIKUNI CORPORATION, Tokyo (JP)

(21) Appl. No.: 11/898,372

(22) Filed: Sep. 11, 2007

(30) Foreign Application Priority Data
Sep. 12, 2006 (JP) 2006-246883

(51) Int. Cl. F02M 33/02

(52) U.S. Cl. 123/518

(57) ABSTRACT

A vapor separator tank for which the separate connection to a canister is not necessary. The inside of a chassis, made of resin, of the vapor separator tank is divided by a wall into a fuel accumulating chamber and a canister chamber. A communication passage is integrally provided on the upper lid of the chassis, and the communication passage communicates the fuel accumulating chamber with the canister chamber. A check valve is provided in the communication passage at the portion thereof connecting to the fuel accumulating chamber. Fuel is supplied from a fuel tank to the fuel accumulating chamber, and when the pressure of evaporated gas in the fuel accumulating chamber reaches a prescribed value, the check valve opens, and the evaporated gas is ejected to the canister chamber. A first outlet connected to an intake pipe of an engine is provided on the uppermost surface of the canister chamber. The canister chamber is filled with activated charcoal, and the evaporated gas is discharged to a scavenging passage via a second outlet provided on a bottom surface of the canister chamber.

### CROSS-REFERENCE TO RELATED APPLICATIONS

This application claims the benefit of Japanese Application No. 2006-246883, filed Sep. 12, 2006, in the Japanese Intellectual Property Office, the disclosure of which is incorporated herein by reference.

### BACKGROUND

1. Field of the Invention

The present invention relates to a vapor separator tank used in a fuel supply system for an outboard motor engine.

2. Description of the Related Art

In an outboard motor engine, for example, the fuel accumulated in the fuel tank is temporarily collected, using a low pressure pump, in a vapor separator tank provided in the outboard motor, then the fuel is supplied to an injector using a high pressure pump, and then injected into the engine by the injector. In the vapor separator of the outboard motor engine, evaporated gas and liquid fuel are separated as the temperature of the engine rises. When the pressure of the evaporated gas generated in the vapor separator tank exceeds a prescribed value, the evaporated gas is supplied to a canister via a check valve and further ejected to an intake pipe. Such a structure for a vapor separator tank is used in a fuel tank in an automobile (Refer to Japanese Unexamined Patent Application No. H11-264348).

However, an outboard motor is coved with a cowling, and since there is no leeway in the layout or in terms of space, disposing a canister and a vapor separator tank in the cowling is a great constraint when designing the outboard motor.

### SUMMARY

Accordingly, an aspect of the invention is to provide a vapor separator tank for which the separate connection to a canister is not necessary.

In accordance with embodiments of the present invention a vapor separator tank includes a fuel accumulating chamber; a canister chamber; and a communication passage to communicate the fuel accumulating chamber with the canister chamber, wherein the fuel accumulating chamber and the canister chamber are integrated, and the communication passage is connected to an upper portion of the fuel accumulating chamber.

A further aspect of the invention is that the inside of a chassis of the vapor separator tank is divided into the fuel accumulating chamber and the canister chamber by a partition plate. The communication passage is preferably integrally formed on an upper lid portion of the fuel accumulating chamber and the canister chamber. In this case, a first outlet to connect a duct which communicates with an intake pipe of an engine is provided in a ceiling portion of the canister chamber.

Yet another aspect of the invention is to have a second outlet to discharge evaporated gas to the outside air preferably provided on the bottom portion of the canister chamber. A check valve, which opens when, for example, the pressure of evaporated gas in the fuel accumulating chamber is a prescribed value or greater, is provided in the communication passage. The chassis is preferably formed from a resin.

As shown above, according to aspects of the present invention, a vapor separator tank for which the separate connection to a canister is not necessary. In this manner, such as space inside a cowling can be preserved, various ducts are simplified, the degree of freedom when designing the layout is increased, and the cost is lowered. Moreover, problems such as ducts rupturing can be solved and reliability is improved.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a schematic drawing of a fuel system for an outboard motor which uses a vapor separator tank, showing the structure of the vapor separator tank, according to an embodiment of the present invention.

### DETAILED DESCRIPTION OF THE EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

An explanation of an embodiment of the present invention will be given below with reference to the drawing.

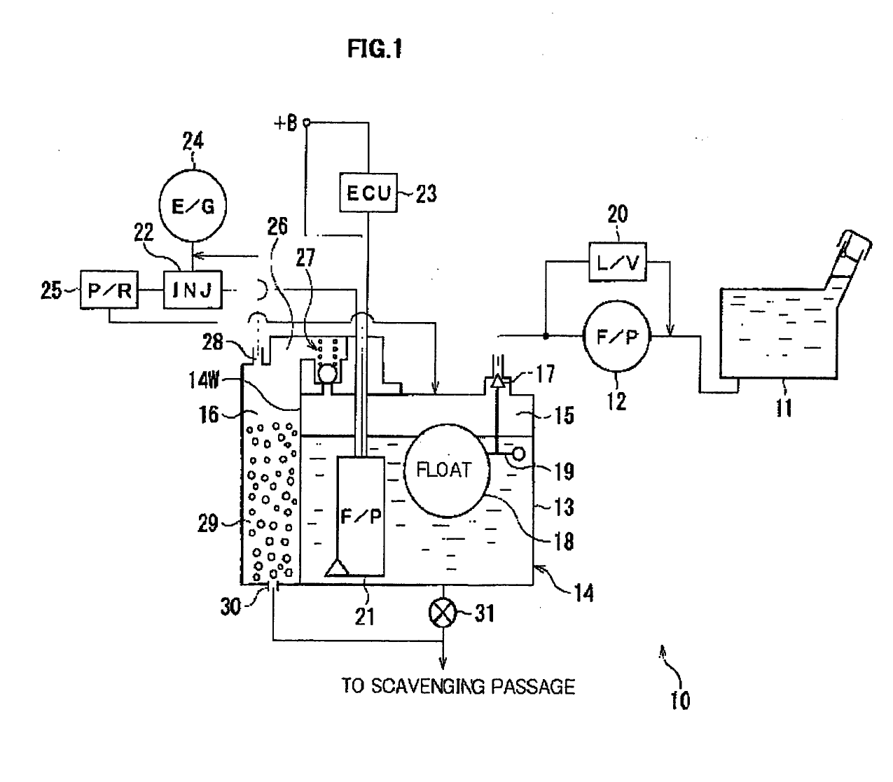

FIG. 1 is schematic drawing of a fuel system for an outboard motor which uses a vapor separator tank, showing the structure of the vapor separator tank, according to an embodiment of the present invention.

In a fuel system for an outboard motor 10, fuel accumulated in a fuel tank 11 is supplied, by a low pressure pump (F/P) 12 to a vapor separator tank 13 provided in a cowling of the outboard motor. A chassis 14 of the vapor separator tank 13 is, for example, made of resin, and an inner portion of the chassis 14 is hermetically divided by a wall 14W into a fuel accumulating chamber 15 and a canister chamber 16.

The low pressure pump 12 supplies fuel to the fuel accumulating chamber 15 of the vapor separator tank 13, and a needle valve 17 is provided in a fuel supply port of the fuel accumulating chamber 15. The needle valve 17 is linked to a float arm 19 which supports a float 18 disposed in the fuel accumulating chamber 15, and the needle valve 17 opens and closes the fuel supply port in accordance with the height of the float 18.

More specifically, one end of the float arm 19 is axially supported by the chassis 14, and the other end is linked to the float 18. The float 18 rises and falls in accordance with the height of the liquid surface of the fuel accumulated in the fuel accumulating chamber 15, the needle valve 17 linked to the float arm 19 opens the fuel supply port when the height of the liquid surface is a prescribed value or less, thus causing fuel to flow, and closes the fuel supply port when the height of the liquid surface is greater than, the prescribed value, thus causing supply of the fuel to cease. In this manner, the height of the liquid surface in the fuel accumulating chamber 15 is maintained at a fixed height. Note that the upstream and downstream sides of the low pressure valve 12 are connected to each other through a relief valve (L/V) 20, and when the fuel pressure on the downstream side reaches a prescribed value, the relief valve 20 opens, and fuel returns to the upstream side.

A high pressure pump (F/P) 21 is disposed in the fuel accumulating chamber 15. The high pressure pump 21 supplies fuel accumulated in the fuel accumulating chamber 15 to an injector (INJ) 22. The high pressure pump 21 is supplied with power by a power source B, and the operation of the high pressure pump 21 is controlled by an electronic control unit (ECU) 23. Note that the injector 22 injects fuel at a prescribed timing into the intake pipe of an engine (E/G) 24. Moreover, a pressure regulator (P/R) 25 is connected to the injector 22 to regulate the injection pressure of the injector 22, and the pressure regulator 25 is also connected to the fuel accumulating chamber 15.

On the uppermost surface which forms an upper lid of the chassis 14, a communication passage 26 is integrally formed with the upper lid so that the fuel accumulating chamber 15 and the canister chamber 16 communicate. A check valve 27 is provided in the opening of the communication passage 26 that opens into the fuel accumulating chamber 15. When the pressure of the fuel which evaporated in the fuel accumulating chamber 15 exceeds a prescribed value, the check valve 27 opens, and the evaporated gas in the fuel accumulating chamber 15 is ejected to the canister chamber 16 through the communication passage 26.

Moreover, a first outlet 28 is provided on the uppermost surface (upper lid) of the canister chamber 16 and is linked to the intake pipe of the engine 24 via a duct. More specifically, the evaporated gas supplied to the canister chamber 16 is ejected to the intake pipe through the first outlet 28 due to the negative pressure of the intake pipe when the engine 24 is operating.

The canister chamber 16 is filled with activated charcoal 29, and a second outlet 30 is provided on the bottom surface of the canister chamber 16. The second outlet 30 is connected to the downstream side of a drain valve 31 provided for releasing the fuel in the fuel accumulating chamber 15, and beyond the drain valve 31 the second outlet 30 is connected to a scavenging passage (not shown in the drawing).

More specifically, when the engine 24 is not in operation, the evaporated gas ejected into the canister chamber 16 passes through the evaporated charcoal 29 layer and is ejected to the scavenging passage from the second outlet 30. At this time, the activated charcoal 29 absorbs and eliminates pollutants, odors and the like included in the evaporated gas.

In the above manner, the vapor separator tank of the present embodiment integrates the fuel accumulating chamber and the canister chamber and thus reduces the size and the cost of the device. Moreover, the communication passage connecting the fuel accumulating chamber and the canister chamber is integrated with the upper lid of the vapor separator tank, thus the various ducts are simplified, and the degree of freedom when designing the layout is increased. Moreover the chassis of the vapor separator tank is made of resin, thus the heat insulating effect is high and the amount of evaporated gas is lowered.

In the present embodiment as described, the fuel accumulating chamber and the canister chamber are completely integrated. However, it is also possible to achieve integration using a cassette structure in which the canister chamber is detachable from the fuel accumulating chamber. With such a cassette structure, it is possible to vary the size of the canister chamber as appropriate to make the canister chamber easy to replace. Moreover, it is possible to reduce the amount of hydrocarbons emitted by the entire ship body by employing a structure which allows communication between the canister chamber and a hermetically sealed fuel tank using a hose or the like.

Furthermore, a structure may also be employed in which the canister chamber encloses the periphery of the fuel accumulating chamber, and in this case a heat insulating effect is obtained from the atmosphere in the canister chamber when there is dead soak or the like.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A vapor separator tank, comprising:
a fuel accumulating chamber;
a canister chamber; and
a communication passage to communicate the fuel accumulating chamber with the canister chamber,
the fuel accumulating chamber and the canister chamber being integrated, and the communication passage being connected to an upper portion of the fuel accumulating chamber.

2. The vapor separator tank according to claim 1, further comprising a chassis having an inside and a partition plate dividing the inside of the chassis into the fuel accumulating chamber and the canister chamber.

3. The vapor separator tank according to claim 1, further comprising an upper lid of the fuel accumulating chamber and the canister chamber and wherein the communication passage is integrally formed on the upper lid.

4. The vapor separator tank according to claim 3, wherein the canister chamber has a ceiling portion, and a first outlet to connect a duct which communicates with an intake pipe of an engine is provided in the ceiling portion of the canister chamber.

5. The vapor separator tank according to claim 4, wherein the canister chamber has a bottom portion, and a second outlet to discharge evaporated gas to the outside air is provided on the bottom portion of the canister chamber.

6. The vapor separator tank according claim 1, wherein a check valve, which opens when the pressure of evaporated gas in the fuel accumulating chamber is a prescribed value or greater, is provided in the communication passage.

7. The vapor separator tank according to claim 2, wherein the chassis is formed from a resin.

8. The vapor separator tank according claim 2, wherein a check valve, which opens when the pressure of evaporated gas in the fuel accumulating chamber is a prescribed value or greater, is provided in the communication passage.

9. The vapor separator tank according claim 3, wherein a check valve, which opens when the pressure of evaporated gas in the fuel accumulating chamber is a prescribed value or greater, is provided in the communication passage.

10. The vapor separator tank according claim 4, wherein a check valve, which opens when the pressure of evaporated gas in the fuel accumulating chamber is a prescribed value or greater, is provided in the communication passage.

11. The vapor separator tank according claim 5, wherein a check valve, which opens when the pressure of evaporated gas in the fuel accumulating chamber is a prescribed value or greater, is provided in the communication passage.
